(19) United States
(12) Patent Application Publication
(10) Pub. No.: US 2007/0068055 A1
(43) Pub. Date: Mar. 29, 2007

(54) Fordable modular light array

(76) Inventors: Marc H. Segan, New York, NY (US); Gary Strauss, Mamaroneck, NJ (US)

Correspondence Address: COHEN, PONTANI, LIEBERMAN & PAVANE, 551 FIFTH AVENUE, SUITE 1210, NEW YORK, NY, 10176, US

(21) Appl. No.: 10/575,058

(22) PCT Filed: Oct. 8, 2004
(86) PCT No.: PCT/US04/33374

§ 371 Date: Apr. 6, 2006

Related U.S. Application Data
(60) Provisional application No. 60/509,496, filed on Oct. 8, 2003.

(51) Int. Cl. G09F 13/22

(52) U.S. Cl. 40/544

(57) ABSTRACT

A display system comprising a plurality of display panels (1-5) connected together serially, each panel including a planar support member (10) having a plurality of parallel first bars (12) connected to a plurality of parallel second bars (14) at intersections (20) to form an open mesh having a front surface (16), a rear surface (17), and a plurality of openings (18) extending between the surfaces (16, 17). A plurality of LED's (30) are mounted in apertures (21) at respective intersections (20), each LED (30) being covered with a translucent cap (33) on the front surface (16) and having a pair of terminals (32) connected to a grid of mutually isolated wires (54, 58) located in channels (13, 15) in the rear surface (17). The panels (1-5) are connected by hinge members (40, 41, 44, 45) which permit the panels to be folded into a stack.

### BACKGROUND OF THE INVENTION

1. Field of the Invention

The invention relates to a display system of the type having an array of lights in rows and columns which can be selectively powered to display textual messages and graphic images.

2. Description of the Related Art

Display signs of all sizes are available for commercial purposes. These signs are typically intended for fixed, relatively permanent installation and may be expensive.

As LED technology has progressed and more luminous LED's have become available in a greater variety of colors, LED based display signs have been developed for consumers. These signs typically employ LED's mounted on one or more printed circuit boards (PCB's). The overall size is limited, because the PCB's are too fragile to be made in large sizes. Large PCB's are also expensive for consumer applications.

Large display signs are also cumbersome to handle, require significant storage space, and may be heavy. When mounted outdoors, their large surface area can catch the wind during installation or use, stresses the sign itself as well as the mounting hardware and the surface to which it is mounted.

### SUMMARY OF THE INVENTION

The display system according to the invention includes a plurality of panels connected together serially, each panel having a planar support member including a plurality of parallel first bars connected to a plurality of parallel second bars at intersections to form an open mesh having a front surface, a rear surface, and a plurality of openings extending between the surfaces, each opening being framed by a pair of first bars and a pair of second bars. A plurality of lights mounted at respective intersections are each visible from the front surface and have a pair of terminals. A grid of mutually isolated wires is located on the rear surface, each wire being located on a respective bar and being connected to a plurality of terminals.

The lights are preferably LED's that are mounted in apertures at the intersections, and the bars are preferably formed with channels that open on the rear surface and receive respective wires that are soldered to terminals of the LED's. Translucent caps are fitted to the front surface over the lights, and cover members are also fitted to the rear surface over terminals. The support member, caps, and covers are preferably made of injection molded plastic and designed to snap together.

A particularly important feature is hinges which connect the panels so that they may be folded to lie in a stack. The panels are also provided with latches which hold them in a coplanar relationship when the sign is opened for display.

The display system according to the invention offers the advantage of being light weight and easy to handle and store, while still being of substantial size when opened so that the panels are coplanar.

The elimination of PCB's makes the system more flexible and less prone to damage when flexed. The use of translucent caps over the LED's simulates a larger bulb which improves the aesthetics when viewed at a distance.

The openings in the panel not only reduce weight but make it pervious to the wind, so that heavy duty mounting hardware is not required. The openings also facilitate mounting by making the sign easy to affix string or wire virtually anywhere on the sign.

Weight is further reduced by removing the transformer and power supply from the sign, preferably locating these components in the supply line between a controller on the first panel and a plug designed for a wall outlet. The transformer reduces the line voltage (e.g. 120 V) to a safe low voltage (e.g. 6 V, 3 A) for the LED's, so that heavy duty insulation of the wires on the support member is not necessary.

The controller on the first panel has a switch which the consumer can set to select display routines designed for horizontal or vertical orientation of the sign.

The individual panels are substantially identical and modular, so that any number of panels can be connected together both mechanically, e.g. by hinges, and electrically, e.g. by plug outlets for ribbon cable. Each support member is designed so that a variety of components can be mounted on the rear surface, in particular so that a controller can be mounted to the first panel. In a preferred wiring scheme, the controller contains not only a CPU and a memory for the display routines, but a row driver for the rows as they extend through all of the panels. Each panel is also provided with a column driver and a splice box which not only distributes wires to rows on the assigned panel, but connects to a splice box for rows on the next panel.

The primary market for the display system according to the invention is expected to be in holiday displays for consumer use. A non-repeating Christmas routine of 10 to 15 minutes can very easily be provided to the display panels with existing chip technology. The controller may be provided with switches to change to a motif for another holiday, such as Halloween.

Another possible markets is for temporary road side signs. For example, the display system could be provided with bright yellow LED's for high visibility. Such signs may be designed for highway departments and may be fully programmable. It could also be designed for consumer use with a fixed message such as “CAUTION”, “HELP”, or “<<<<” (arrows), and may be powered from a car's cigarette lighter for 12 volt operation. This version would not have a transformer, but would require a different power circuit. There could also be a power box with four D-cell batteries for 6 volt operation. Since only two or three panels and fewer control functions would be needed, this version could be produced at lower cost than a holiday display. This version would be suitable for carrying in a consumer's car trunk as a substitute for flares. Use by the police is also envisioned.

### BRIEF DESCRIPTION OF THE DRAWINGS

In the drawings:

FIG. 1 is a perspective view of a lighting system according to the present invention, shown in the open position;

FIG. 2 is a perspective view of the system in the partially folded position;

FIG. 3 is a side view of the lighting system in the open position;

FIG. 4 is a front plan view of a single panel;

FIG. 5 is a rear plan view of a single panel;

FIG. 6 is a perspective view of part of the rear surface of a support member;

FIG. 7 is an exploded side section view of part of a panel showing the support member, light, cap, and cover;

FIG. 8A is a plan view of two adjacent support members and a front hinge;

FIG. 8B is an exploded perspective view of two adjacent support members and a rear hinge;

FIG. 9 is a side section view the lighting system in a fully folded position;

FIG. 10 is a schematic wiring diagram for the system;

FIG. 11 is a schematic wiring diagram of the controller for the system;

FIG. 12 is a schematic wiring diagram for the column driver of a single panel; and

FIG. 13 is a schematic wiring diagram of a single panel.

### DETAILED DESCRIPTION OF THE PRESENTLY PREFERRED EMBODIMENTS

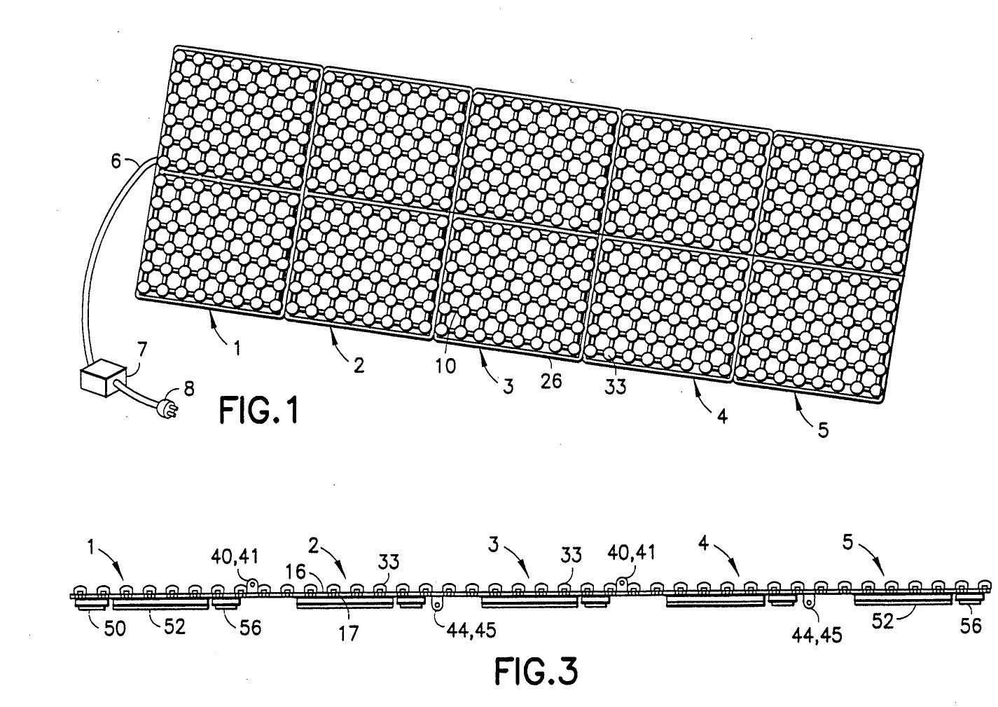

FIG. 1 shows a plurality of lighting panels 1-5 which are connected together serially to form a display sign having a power cord 6, a transformer 7 in the power cord, and a plug 8. Each panel 1-5 includes an injection molded plastic support member 10 in the form of an open mesh surrounded by a frame 26 and carrying light caps 33 in an array of rows and columns. In the example shown, the light caps 33 on each panel are arranged in a 12×8 array, and cover respective lights mounted in the support member. The frames 26 are connected by hinges and are also provided with latches to lock the panels in a coplanar relationship. In a currently contemplated embodiment, each panel is 12″ wide by 18″ high, so that the display sign is 5′ wide by 18″ high and includes 480 LED's, which are located under the cap members and may be collectively referred to as lights.

The panels are substantially identical and modular so that any number can be connected together serially to form a display sign of any desired length. The lights, which are preferably LED's, can be selectively lit to form a display sign, and may be programmed to be addressed in sequential patterns to create the impression of moving images in a well known manner. A controller is provided to sequence the activation or addressing of the lights according to a desired program which may have a holiday motif, displaying messages such as “MERRY CHRISTMAS” which scroll across the panels, and graphic images such as Christmas trees or Santa's boots walking across the panels.

The messages and/or images may vary continuously until a cycle is completed, whereupon they repeat. The controller, which is preferably mounted to the back of the first panel 1, may be switched to a program with a different motif, and may also be programmed by the user to present any desired image or message. Additionally, the controller may be switched to a vertical mode, wherein it displays messages or images which are properly oriented when the panels are arranged vertically. While any number of panels may be connected together to form a sign, the controller will generally be programmed based on the number of interconnected panels.

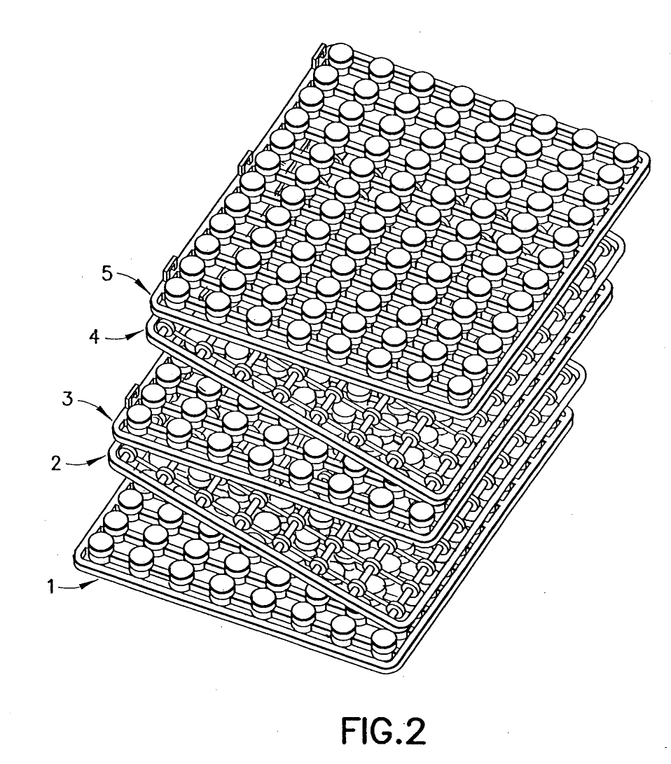

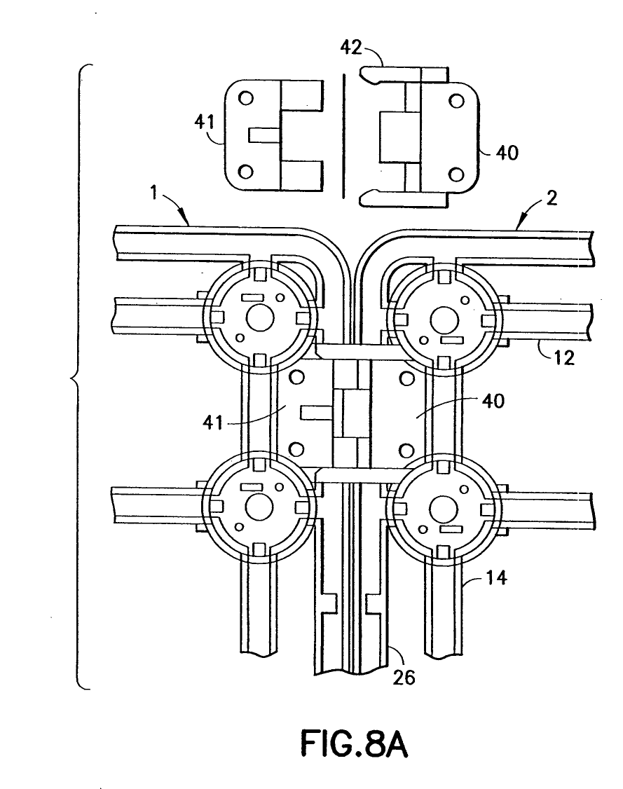

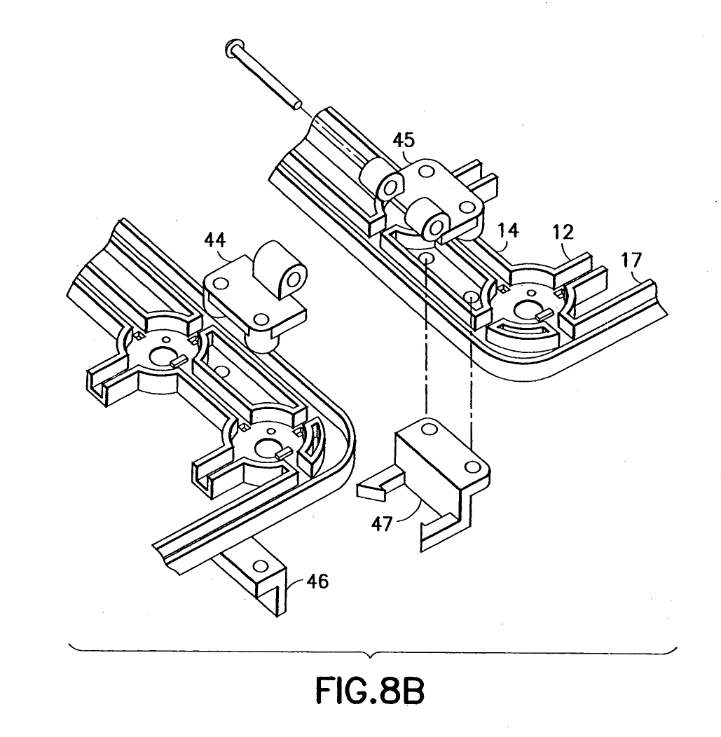

FIG. 2 shows the sign in a partially folded configuration, the first and second panels 1, 2 being hinged so that their front surfaces can be brought into a mutually facing relationship, the second and third panels 2, 3 being hinged so that their rear surfaces can be brought into mutually facing relationship. When fully folded, as shown in FIG. 8, the panels are all substantially parallel so that they may be conveniently handled and stored in a box.

FIG. 3 is a side view of panels 1-5 showing coplanar front surfaces 16 and coplanar rear surfaces 17 of the support members 10. The front surfaces 16 carry the light caps 33, and the rear surfaces 17 carry electronic components including controller 50, which includes a row driver for all five panels, column drivers 52, and splice boxes 56. The panel pairs 1, 2 and 3, 4 are hinged together by front hinge members 40, 41 so that the front surfaces 16 of each pair can be folded into mutually facing parallel relationship while maintaining a certain spacing to accommodate the light caps 33. The panel pairs 2, 3 and 4, 5 are hinged together by rear hinge members 44, 45 so that the rear surfaces 17 of each pair can be folded into mutually facing parallel relationship while maintaining a certain spacing to accommodate the components 52, 56.

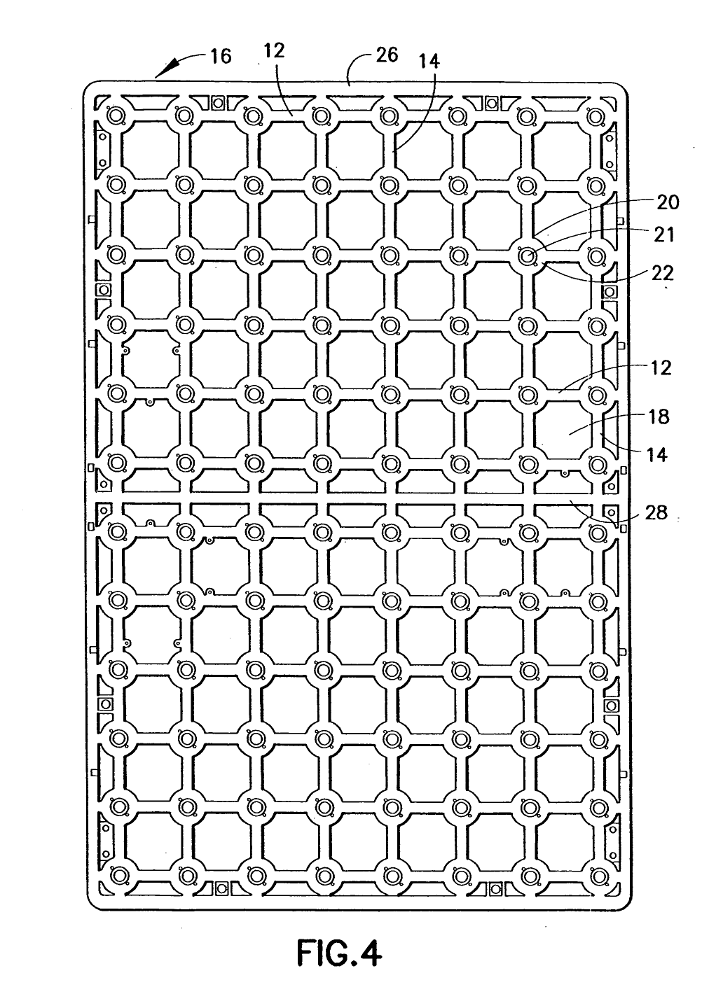

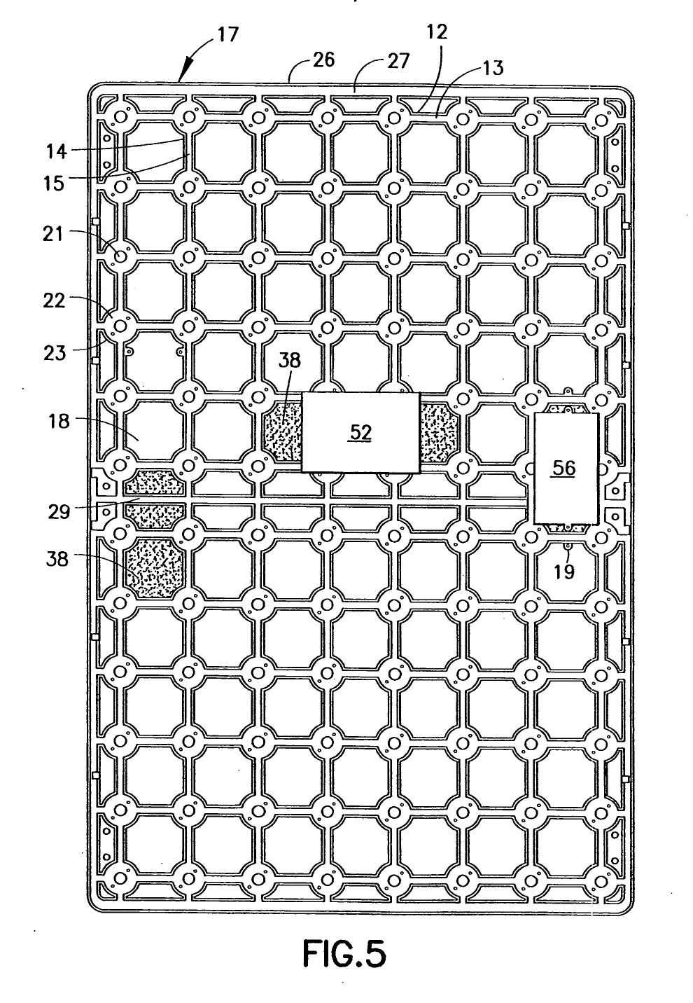

FIG. 4 shows the front surface 16 of panel 1 in greater detail. Each support member 10 includes an array of first or horizontal bars 12 connected to second or vertical bars 14 at intersections 20 to form an open mesh surrounded by a circumferential frame 26 and intersected by a cross member 28. The openings 18 are framed by the bars 12, 14 and extend between front surface 16 and rear surface 17 (FIG. 5). Each intersection 20 has a central aperture 21 surrounded by a support base 22 which reinforces the intersections 20 and provides means for fixing a cap 33 to the front surface and a cover 36 to the rear surface, as will be described.

FIG. 5 is a detailed view of the rear surface 17 of panel 1. Each horizontal bar 12 has a channel 13 which receives a respective wire for connection to one terminal of each LED in a row. Each vertical bar 14 has a channel 15 which is connected to one terminal of each LED in a column. The circumferential frame 26 has a channel 27 which can carry bundles of wires for distribution to the row channels 13, and the crossbar 28 has a channel 29 which can carry bundles of wires for distribution to column channels 15. While the wires in the bundles must be mutually insulated, the insulation may be stripped from the wires where they lie in the channels 13, 15, which facilitates soldering or otherwise connecting to the terminals of the LED's. The support base 22 is surrounded by a wall 23 which is flush with the tops of the channels 13, 15 and forms a recess for receiving a back cover over the terminals of the LED received in aperture 21. The portions of sidewalls of channels 13, 15 surrounding some of the openings 18, as well as portions of walls 23 connecting those sidewall portions, are cut away to create recesses for floor members 38, which are received flush with the rear surface 17 and provide mounting surfaces for the electronic components 50, 52, 56. The electronic components may also mounted directly to the floor members 38, or may be mounted to holes in offsets 19 molded integrally with the support member 10. In the example shown, the splice box 56 is mounted to the floor members 38, while the controller 50 and column driver 52 are fixed directly to the support member 10.

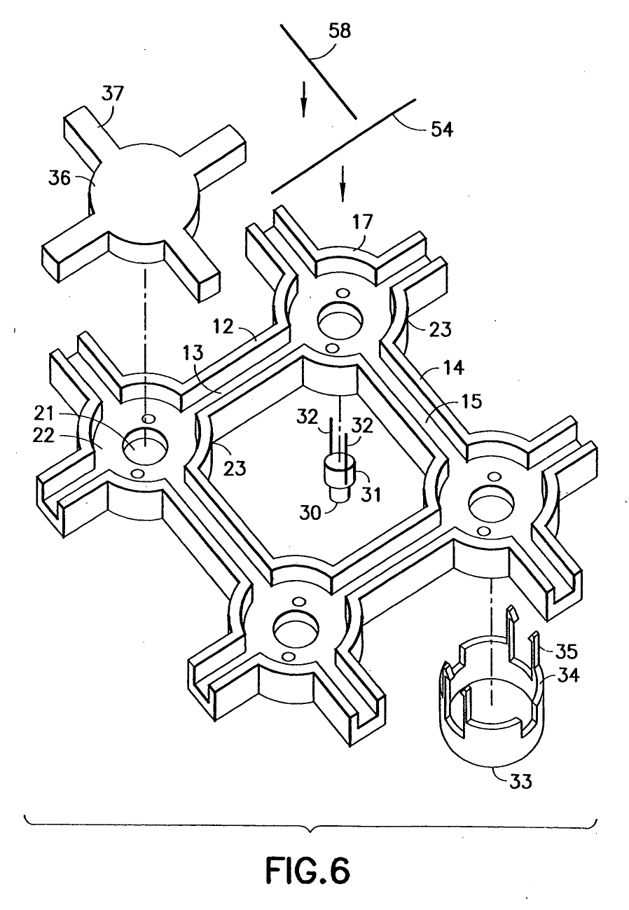

FIG. 6 shows the bars 12, 14, channels 13, 15, and support base 22 with surrounding wall 23. The LED 30 is mounted in a plastic base 31 so that the terminals 32 are electrically separated by the base 31 for soldering to wires 58, 54 in respective channels 13, 15. Each base 31 also serves to electrically separate the wires in the respective channels, so that current can only pass through the crossed wires via the associated LED. The base 31 is pressed into aperture 21 until it lies below the rear surface 17.

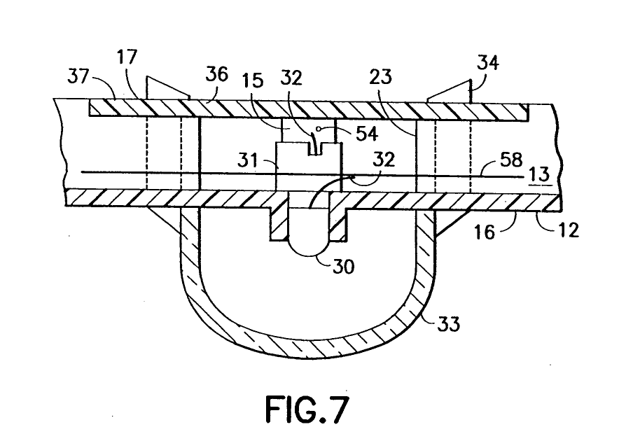

FIGS. 6 and 7 show a rear cover 36 having radially extending arms 37. When the cover 36 is snapped in place over a support base 22 and is flush with the rear surface 17, the arms 37 extend into adjacent channels 13, 15 and abut the arms of adjacent cover members 36 so that the channels 13, 15 are completely covered. The arms 37 of cover members adjacent to the circumferential frame 26 extend over the channel 27 and may serve to retain wires in the channel 27; these arms may be foreshortened as necessary. Retention of the rear covers 36 may be enhanced by posts which are received in holes in each support base.

A translucent plastic cap 33 is fitted against the front surface 16 over each exposed LED, and serves to diffuse the light emitted by the LED. Each cap 33 has a castellated lip 34 which is mated to a pair of bars 12, 14, and two pairs of latch arms 35 which are received around one of the bars 12, 14 on either side of the support base 22, the latch arms 35 having detents which engage the rear surface 17. The floor members 38 are provided with apertures which receive the latch arms so that the detents can retain the floor members 38 flush with the rear surface. The panel may also be provided with U-shaped clips which are applied to bars 12, 14 from the rear to hold ribbon cable or wires in place.

FIG. 8A shows front hinge members 40, 41 which can be fixed to respective support members 10 between the column bars 14 and the circumferential frame 26. Each hinge member 40, 41 is screwed to a retaining plate 43 received in the rear surface of the respective support member 10, the members 40, 41 having bores which are coaxially aligned to receive a pin along a pivot axis. The pivot axis is located directly over the interface between the adjacent frames 26, which are designed so that the spacing between outermost columns of adjacent panels is the same as the spacing between columns in a panel. The member 40 is provided with latches 42 which engage the member 41 to hold the panels 1, 2 and 3, 4 in a coplanar relation when the lighting system is in the open position.

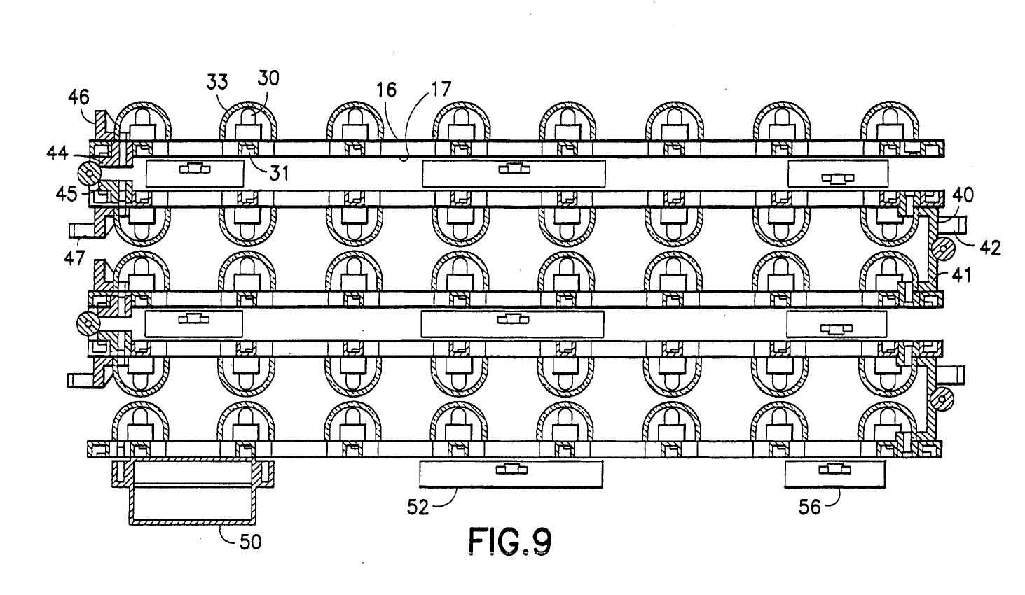

FIG. 8B shows rear hinge members 44, 45 which are fixed to respective support members 10 between the column bars 14 and the circumferential frame 26. Each hinge member 44, 45 is screwed to a respective latch member 46, 47 which is received against the front surface of the respective support member 10, the members 44, 45 having bores which are coaxially aligned to receive a pin along a pivot axis. The latch members 46, 47, which are shown in side view in FIG. 9, hold the panels 2, 3 and 4, 5 in a coplanar relation when the lightening system is in the open position.

FIG. 9 shows the panels 1-5 in the fully folded position. The hinge members 40, 41 and 44, 45 are designed to keep the hinged edges of the support members 10 in spaced relation in order to accommodate the light caps 33 on the mutually facing surfaces 16, and to accommodate the components 52, 56 on the mutually facing rear surfaces 17.

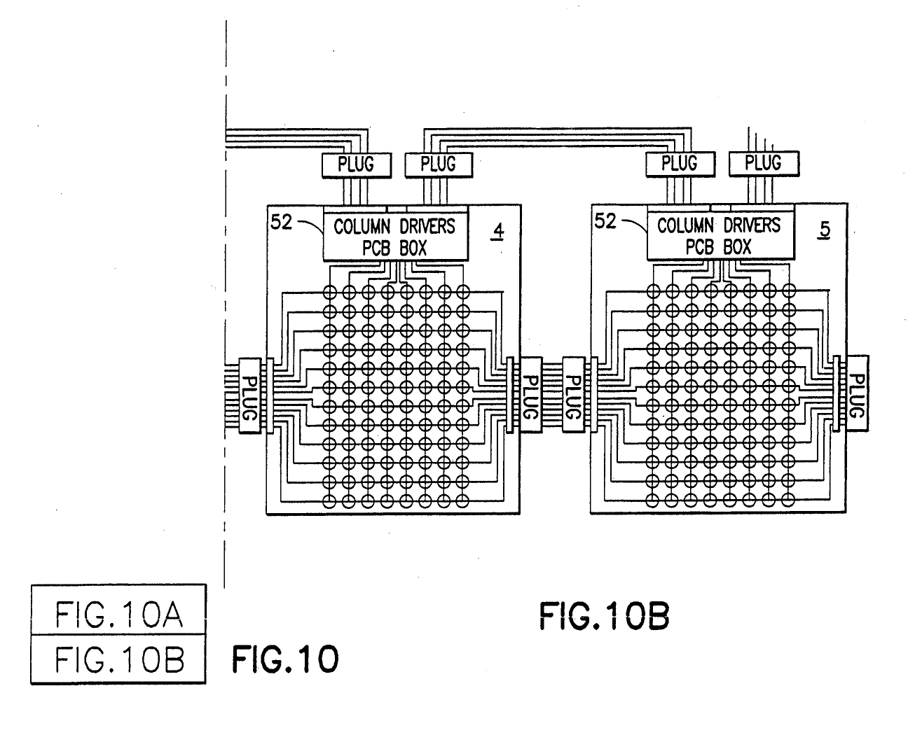

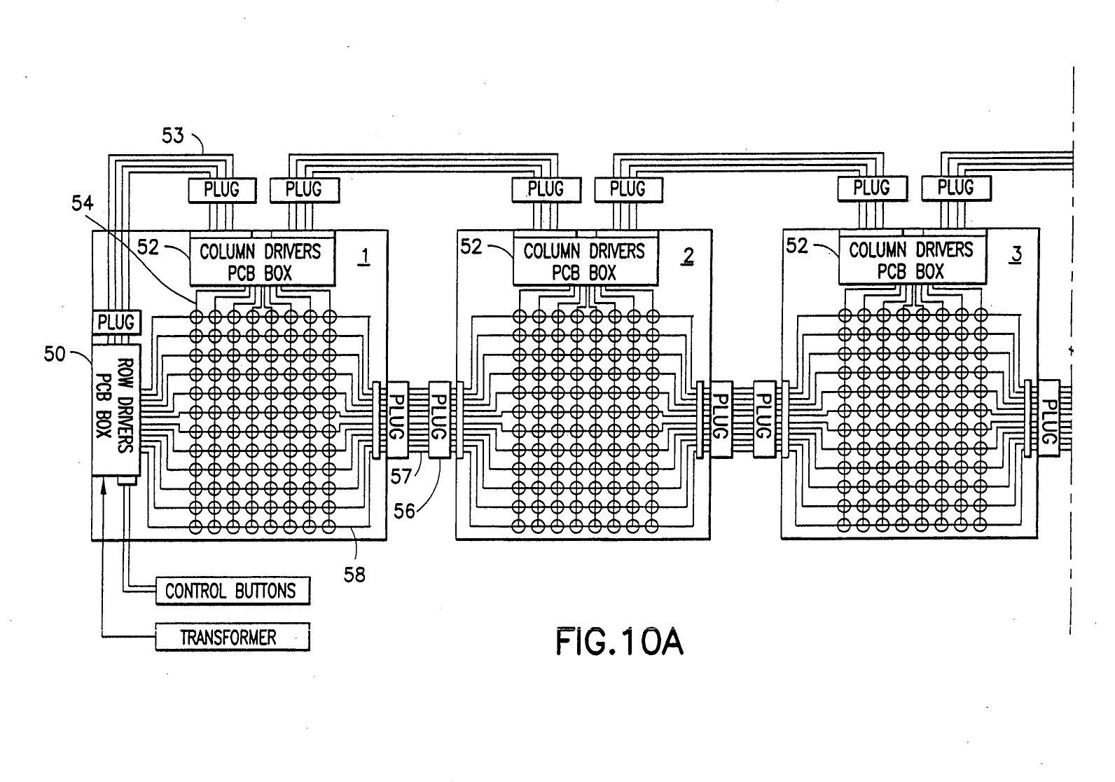

FIG. 10 is a wiring schematic showing the wiring grids for the respective panels 1-5 and their connections. A controller 50 is connected to the first column driver 52 by ribbon cable 53, and to the first splice box 56 by ribbon cable 57. The controller 50 includes a row driver for all five panels via splice boxes 56, which are interconnected by further ribbon cables 57. The splice boxes 56 distribute wires 58 to rows of LED's on each panel. Each column driver 52 includes an LED driver chip, and is connected to successive column drivers 52 by further ribbon cables 53. Each column driver 52 distributes wires 54 to LED's in columns of the panel to which it is mounted. The overall size of a five panel array is therefore 12×40, wherein the twelve rows are driven by the controller 50 and the forty columns are driven by the five column drivers 52. The conductors in each ribbon cable 53, 57 carry the voltage and ground necessary to power the LED's, as well as the data and clock signals necessary to selectively apply power to the wires 58, which connect the row and column drivers 50, 52 to the LED's in the array.

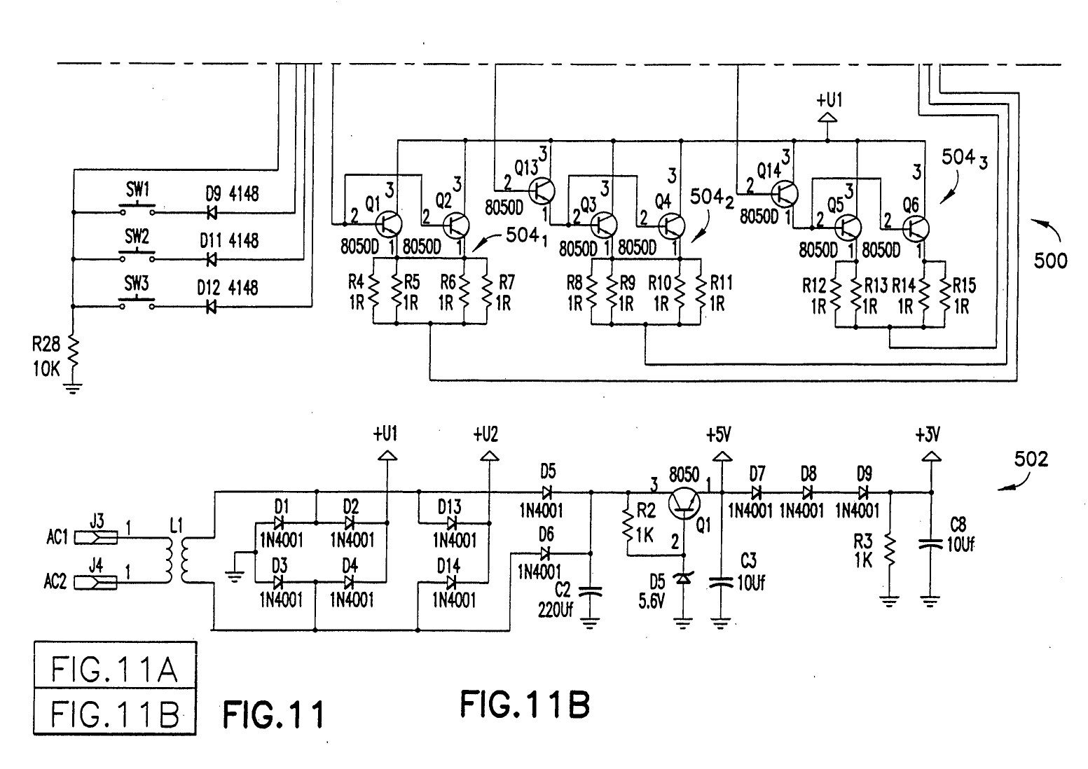

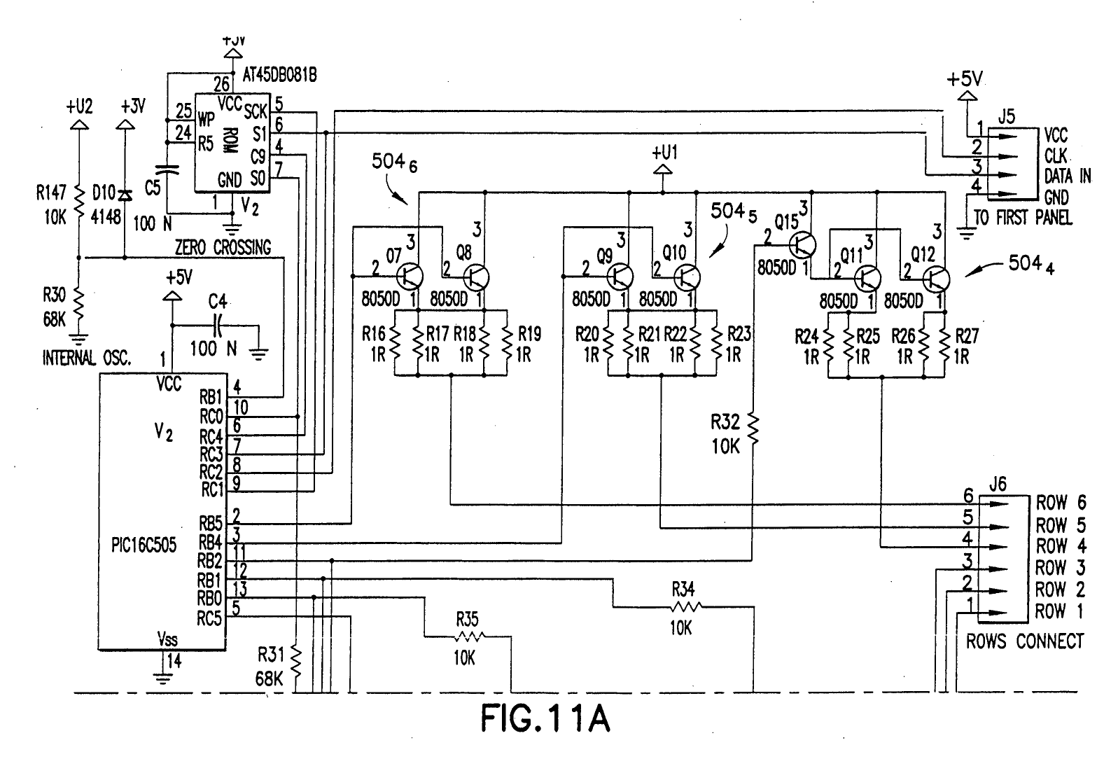

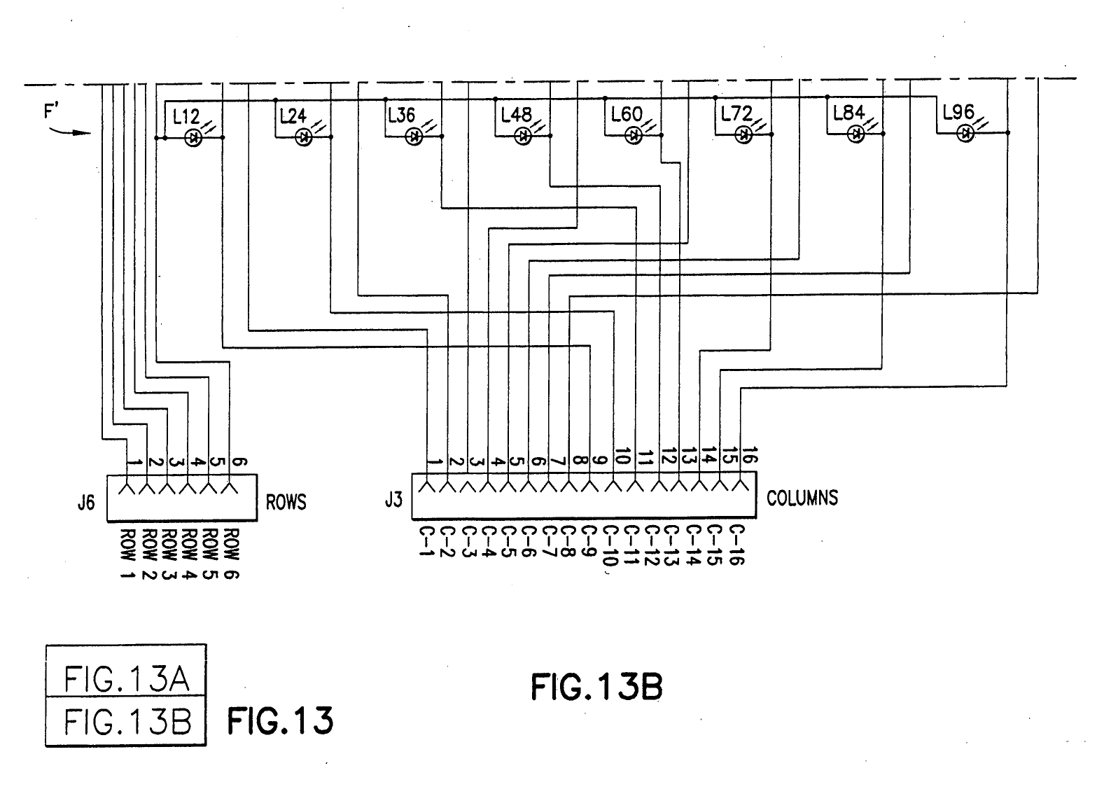

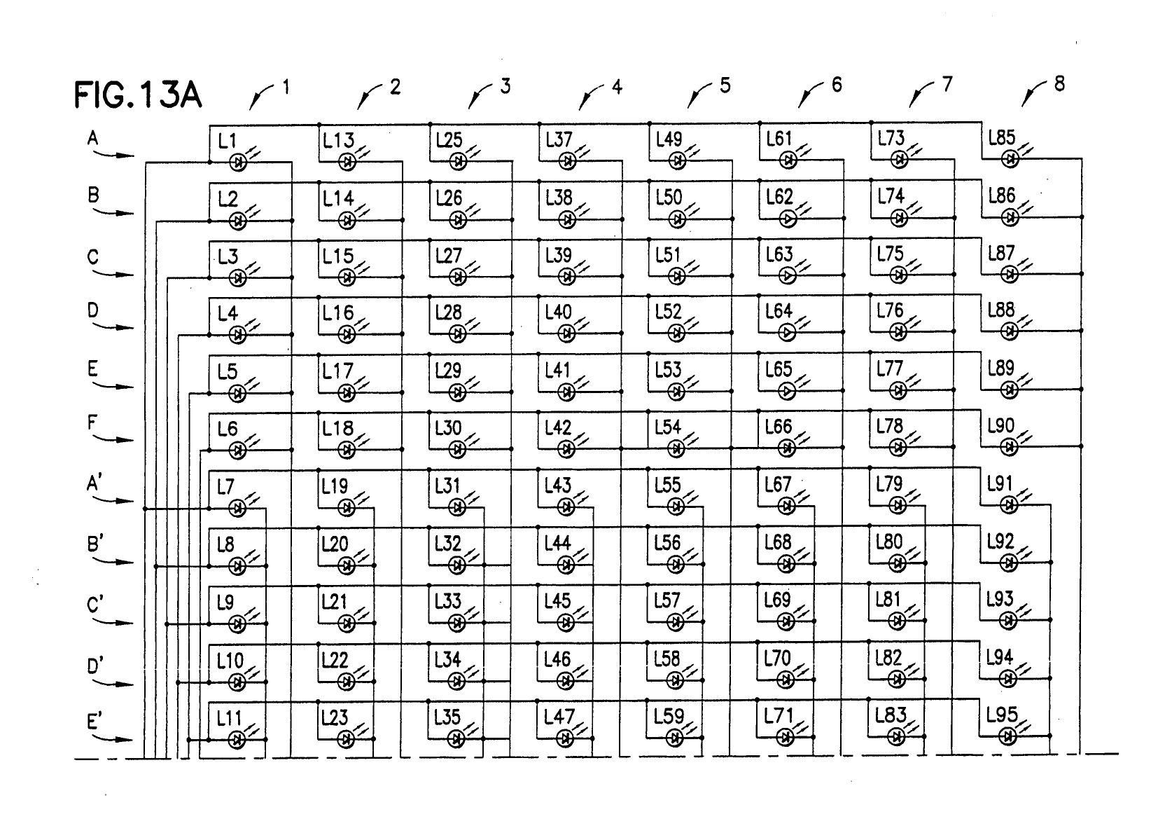

A row driver circuit 500 for controlling rows of LEDs in accordance with the preferred embodiment is shown in FIG. 11. Row driver circuit 500 is included only on the first or “master” panel 1 and receives power from a power circuit 502, which provides the voltages +U1, +U2, +5V and +3V required for circuit operation. Circuit 500 includes six row driver stages 504₁-504₆ for producing driver current to the LEDs, with each stage controlling a corresponding row of LEDs. For example, row driver stage 504, provides driver current to line 1 on connector J6 which, as shown in FIG. 13, will apply the driver current to one of the two terminals of each of the LEDs L1, L13, L25, L37, L49, L61, L73, and L85, arranged in row A, and to one of the two terminals of each of the LEDs arranged in row A′ (L7, L19, L31, L43, L55, L67, L79 and L91). Likewise, driver stage 504₆ will output driver current to line 6 on connector J6 which, in turn, is applied to the LEDs in rows F and F′ (see FIG. 13).

A microprocessor V1 contained on the first or “master” panel 1 receives pattern data corresponding to the available illumination “programs” from a read only memory (ROM) chip V2 and provides control voltages to the individual row driver stages 504 for producing the driver currents. As will be appreciated, in order for the LEDs to be illuminated, driver currents must also be present at the second terminal of each LED. This is accomplished by column driver chips U3 associated with each panel, as explained below. Switches SW1, SW2 and SW3 are also provided for user interaction with the device such as, for example, powering the device on and off, user selection of the specific programs to generate LED illumination of specific motifs, etc.

When multiple panels are employed, the connectors J6 are connected to each other so that the row driver signals from the first panel are provided to common rows in all of the subsequent or downstream panels. As shown in FIG. 11, the DATA IN signal from microprocessor V1 is supplied to connector J5 for use in LED column control. Also, a control clock signal CLK is provided from the microprocessor V1 to connector J5 for use in synchronizing activation of the LEDs in the subsequent panels, in accordance with the present invention.

To connect the first “master” panel to a second panel, the connectors J5 and J6 of the first panel will mate with connectors J1 and J6, respectively, of the second panel. The second panel can be connected to a third panel by mating the second panel connectors J2, J6 with the third panel connectors J1, J6, respectively. Additional panels are connected in a like manner to the connection between panels 2 and 3.

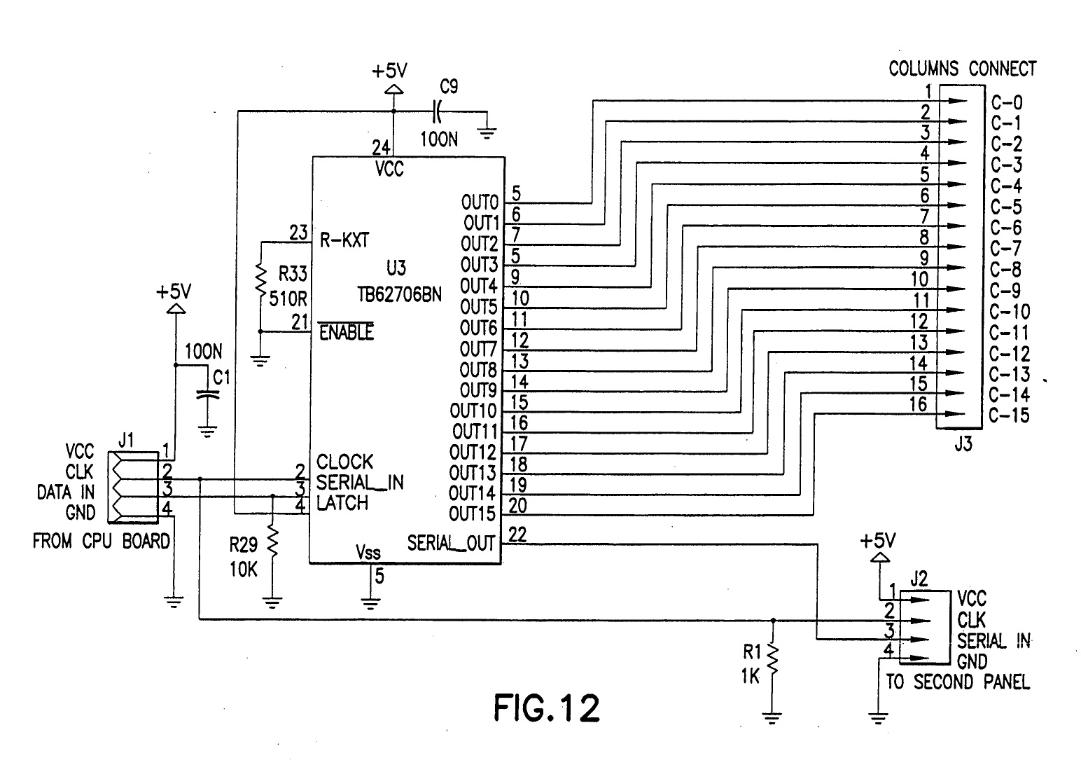

With reference to FIGS. 12 and 13, the LED column activation function will now be described. As shown in FIG. 12, a connector J1 will receive the DATA IN signal and control clock signal from connector J5 of FIG. 11 and provide the control clock signal and the data bits from the DATA IN signal to the individual connected panels. The DATA IN signal comprises a string of data bits which are supplied serially to the column driver chips U3 associated with each panel. Each chip U3 is a 16 bit shift register and current driver, and receives the data bits from the microprocessor V1 under the control of the clock. The data bits are serially shifted by each U3 chip until they fill all downstream column driver chips. For example, if 80 bits of data are to be used to control the LEDs in five panels, as is presently contemplated in the preferred embodiment, 16 bits of data will be sequentially received in each column driver U3 chip until all 80 bits have been delivered. The outputs from each column driver are provided to lines 1-16 on connector J3 on each panel which, as shown in FIG. 13, are applied to the other of the two terminals of each LED in the LED rows, i.e. to the terminal that is not connected to the row driver stages 504. For example, line 1 of connector J3 will control one of the two terminals of LEDs L1-L6 (the others being controlled by the row driver circuits 504), while line 9 from connector J3 will control one of the terminals of LEDs L7-L12. Thus, once the data bits are delivered through the column drivers U3, driver current is provided to the LED terminals in accordance with the data bits. At that point, activation of a particular row driver circuit 504 provides a driver current to the other terminal of each LED in that row (e.g., row A-A′) so that, if certain of those LEDs also have a driver current present at their other terminals by way of the column drivers, the LEDs will be illuminated. Thus, once the data bits are delivered through the column drivers U3, the column driver outputs to the LED terminals are energized in accordance with the data bits. At that point, activation of a particular row driver circuit 504 provides a driver voltage to the other terminal of each LED in that row (e.g., row A-A′) so that, if certain of those LEDs also have an active column driver terminal, those LEDs will be illuminated. Then the row driver is de-energized, new data is shifted into the column drivers U3 chips and the next applicable row driver circuit is activated. This process is repeated for the four remaining row driver circuits in rapid succession which is undetectable to the eye in a normal muliplexing fashion. The timing is accomplished in synchrony with the half-wave time of the 60 Hz power supply, approximately 8.3 milliseconds per row. In this manner, versatile and efficient control of the individual LEDs is provided.

We claim:

1. A display system comprising at least one display panel, each said at least one panel comprising:
a planar support member comprising a plurality of parallel first bars connected to a plurality of parallel second bars at intersections to form an open mesh having a front surface, a rear surface, and a plurality of openings extending between said surfaces, each said opening being framed by a pair of said first bars and a pair of said second bars;
a plurality of lights at respective said intersections, each said light being visible from said front surface and having a pair of terminals; and
a grid of mutually isolated wires located on said rear surface, each said wire being located on a respective said bar and being connected to a respective one of each said pair of terminals located at the intersections on the respective said bar.

2. A display system as in claim 1 further comprising an aperture at each said intersection, each said aperture serving as a socket that receives a respective said light.

3. A display system as in claim 1 wherein said lights are LED's.

4. A display system as in claim 1 wherein said support member further comprises a support base surrounding each said intersection.

5. A display system as in claim 4 further comprising a light-transmitting cap fixed to the front surface over each said support base.

6. A display system as in claim 5 wherein each said cap is provided with arms which extend through said openings and engage said rear surface of said support member.

7. A display system as in claim 1 wherein said bars are formed with channels that open on the rear surface and receive respective said wires therein.

8. A display system as in claim 7 further comprising a plurality of covers fixed to the support member over respective said intersections.

9. A display system as in claim 8 wherein each said cover has a central portion over the intersection and four arms that extend radially into the channels of the first and second bars that are connected at the intersection, each said cover being substantially flush with said rear surface.

10. A display system as in claim 1 wherein said support member further comprises a circumferential frame surrounding said open mesh.

11. A display system as in claim 10 wherein said frame is provided with channels which can carry said wires in bundles for distribution to said grid.

12. A display system as in claim 10 further comprising a cross member extending across said circumferential frame between an adjacent pair of said first or second bars.

13. A display system as in claim 1 wherein said rear surface of said support member is provided with recesses surrounding some of said openings, said panel further comprising floor members which are received in said recesses flush with said rear surface, and at least one electronic module mounted to said floor members.

14. A display system as in claim 13 further comprising a light-transmitting cap fixed to the front surface over each said support base, wherein said cap is provided with arms which extend through said openings and engage said rear surface of said support member, at least some of said arms engaging said floor members to hold said floor members in said recesses.

15. A display system as in claim 1 comprising a plurality of said display panels connected together serially.

16. A display system as in claim 15 wherein each said panel comprises at least one plug member for connecting to wires on an adjacent said light panel.

17. A display system as in claim 15 wherein at least two said panels are connected by hinges so that said panels can be folded together to form a stack.

18. A display system as in claim 17 wherein said hinges comprise at least one first hinge connecting a first pair of said panels so that said first pair of panels can be folded together with their front surfaces in mutually facing relation, and at least one second hinge connecting a second pair of said panels so that said second pair of panels can be folded together with their rear surfaces in mutually facing relation.

19. A display system as in claim 18 wherein each said first hinge is fixed to said front surfaces and designed so that said front surfaces are spaced apart when said panels of said first pair are folded together, and each said second hinge is fixed to said rear surfaces and designed so that said rear surfaces are spaced apart when said panels of said second pair are folded together.

20. A display system as in claim 15 wherein said panels are modular, at least some of said panels being substantially identical.

21. A display system as in claim 15 further comprising a power cord to one of said panels, each serially connected panel being provided with power from said one of said panels.

22. A display system as in claim 21 further comprising a transformer for reducing mains voltage to a low voltage suitable for powering LED's, said transformer being located in said power cord.

23. A display system as in claim 21 wherein said power cord is provided with a plug for inserting in a car's cigarette lighter.

24. A display system as in claim 1 wherein said support member is injection molded plastic.

25. A display system as in claim 1 further comprising a controller for driving said lights in a moving display mode in at least one of a horizontal format and a vertical format.

26. A display system as in claim 25 wherein said controller comprises a switch for switching between a vertical format and a horizontal format.

27. A display system as in claim 25 wherein said controller is fixed to the rear surface of a first one of said support members.

28. A display system as in claim 15 wherein said first bars represent rows of said lights and said second bars represent columns of said lights, said system further comprising a row driver for driving the rows of all of said panels and a plurality of column drivers for driving the columns of respective panels.
